(19) United States
(12) Patent Application Publication
(10) Pub. No.: US 2014/0038806 A1
(43) Pub. Date: Feb. 6, 2014

(54) CENTRIFUGAL SEPARATOR, WEAR RESISTANCE MEMBER AND SET OF WEAR RESISTANCE MEMBERS FOR A CENTRIFUGAL SEPARATOR

(71) Applicants: Willi B. Lendzian, Ballerup (DK); Hans Lauge Joakim Svarrer, Graested (DK); Henrik Reiff, Farum (DK)

(72) Inventors: Willi B. Lendzian, Ballerup (DK); Hans Lauge Joakim Svarrer, Graested (DK); Henrik Reiff, Farum (DK)

(73) Assignee: ALFA LAVAL CORPORATE AB, Lund (SE)

(21) Appl. No.: 13/884,797

(22) PCT Filed: Nov. 10, 2011
(86) PCT No.: PCT/DK2011/050424

§ 371 Date: Oct. 25, 2013

(30) Foreign Application Priority Data
Nov. 12, 2010 (DK) PA 2010 70483

(51) Int. Cl. B04B 7/12

(52) U.S. Cl. CPC B04B 7/12
USPC 494/56

(57) ABSTRACT

A centrifugal separator includes a bowl with a conical part with a narrow discharge end comprising a radial surface; an end member opposite the radial surface; a number of distance members extending between the radial surface and the end member and providing outlet openings between adjacent distance members; and wear resistance members covering surfaces at the outlet openings, wherein the wear resistance members comprise bushing members with mantle portions surrounding respective distance members.

### FIELD OF THE INVENTION

The present invention relates to a centrifugal separator comprising a bowl rotatable around an axis of rotation extending in a longitudinal direction of the bowl. The bowl comprising a conical part with a narrow discharge end comprising a radial surface; an end member opposite the radial surface; a number of distance members extending between the radial surface and the end member and providing outlet openings between adjacent distance members. The distance members have an axial extend in an axial direction of the axis of rotation and a circumferential extend perpendicular to the axial extend; and wear resistance members covering surfaces at the outlet openings.

The invention further relates to a wear resistance member for such centrifugal separators and to a set of wear resistance members for the centrifugal separators.

### BACKGROUND OF THE INVENTION

It is well known to provide wear resistance members at the solid phase or heavy phase outlet of a centrifugal separator since the solid phase separated from a feed inside the bowl of the centrifugal separator is abrasive in some applications such as drilling mud.

U.S. Pat. No. 5,244,584 discloses a centrifugal separator wherein L-shaped wear resistance members are provided to protect the surfaces of the distance members directly exposed to the out-flowing solid phase. The leg of the L-shaped member beyond the external surface of the bowl. The L-shaped member is fastened by a bolt inserted through the distance member and into the L-shaped member from the outside. The L-shaped member is dimensioned in a way so that it can be inserted and fitted without the bowl having to be dismantled. The L-shaped members are of a complicated construction involving many parts to be assembled.

The bowl is usually accommodated in a casing with compartments receiving the material being discharged from the outlets of the bowl e.g. the solid phase. The solid phase may build-up in the receiving compartment until it reaches the outside of the bowl at the outlets causing abrasion of the bowl. The leg of the L-shaped member extending beyond the external surface of the bowl may act as a scraper to reduce this problem. The L-shaped members are built from several pieces and thus have a complicated construction.

U.S. Pat. No. 7,374,529 discloses another centrifugal separator wherein U-shaped wear resistance members are inserted in the outlet openings from the outside and fastened from the outside by means of bolts inserted through external flanges of the U-shaped member and fastened in the material of the bowl. The bolts thus have to counteract the centrifugal force acting on the U-shaped member. The U-shaped members extend beyond the external surface of the bowl. Spacers are fastened between the U-shaped members to the external side of the distance members by means of bolts counteracting the centrifugal force acting on the spacers. Since the material used for wear resistance members are usually brittle, using bolts introduced through the wear resistance member from the outside may cause a strength problem.

### SUMMARY OF THE INVENTION

There is disclosed herein a wear resistance member including a bushing member with a mantle portion surrounding a respective distance member at least around a sufficient portion of the circumferential extend of the distance member to prevent removal of the bushing member in a direction perpendicular to the axial direction. Thus the need for bolts penetrating the wear resistance members from the outside to counteract the centrifugal force is avoided, because the bushing members are securely carried by the distance members. Providing wear members in the form of bushings requires that these wear members must be fitted on the distance members before the end member of the centrifugal separator is assembled with the conical part of the bowl. Correspondingly, dismantling is necessary in order to renew the wear members. However, using a high quality wear resistance material renewal is needed only at such long intervals, that this drawback is inferior to the benefits of the invention.

In one embodiment the mantle portion of the bushing member is tubular and circumferentially surrounds the distance member completely, resulting in an effective protection of the outside of the distance members against abrasion.

In another embodiment the mantle portion of the bushing member has a C-shaped cross-section perpendicular to the axial direction. Further the wear resistance members preferably comprise a plurality of plate members each covering a portion of the radial surface, resulting in a simple construction facilitating use of high quality wear resistance materials, such as tungsten carbide.

In one embodiment the bushing member has at one end a flange abutting the radial surface and covering a portion of the radial surface. Preferably a plate member is fitted on the radial surface between adjacent bushing members. Edges of the flanges of the bushing members overlap edges of the plate members, thereby the plate members are retained against the radial surface by the bushing members. Preferably the plate members have a waist portion, the flanges being configured to engage the waist portion and secure the plate members due to the overlap and the waist portion, to retain the plate members in both radial directions.

In one embodiment, the plate members respectively comprise an opening for a distance member to extend through, and an edge of a plate member overlaps an adjacent edge of an adjacent plate member. Preferably the plate member comprises a hole for a fastening member, and the opening for a distance member is adapted to accommodate an end of a bushing member. Due to the distance member and further the bushing member passing through and into, respectively, the opening in the plate member, the plate member is retained against the centrifugal force by the distance member together with the bushing member. Preferably the plate members are in this embodiment mounted e.g. by means of an adhesive (e.g. glue) on a flat steel ring with corresponding holes and a openings, whereby the steel ring with the plate members is secured by fasteners such as bolts inserted through the holes and tightened against rims of the holes in the steel ring with out being tightened against the rims of the holes of the plate members. The plate member holes having a larger diameter than the holes of the steel ring. The fastener, e.g. a bolt, inserted through the hole in the plate member will only actively retain the plate member in case the adhesive fails and then mainly retain the plate member in an axial direction, in which direction the force acting on the plate member is small relative to the centrifugal force.

In one embodiment, a concave edge of the wear resistance members covering a portion of the radial surface includes an extension rising from a plane of the wear resistance member, whereby the extension is arranged to extend around an internal edge of the conical part adjacent the radial surface to protect the internal edge of the conical part adjacent the radial surface.

Preferably the wear resistance members comprise tungsten carbide.

Preferably the distance members, and accordingly the mantle portions of the bushing members, have a non-circular cross-section perpendicular to the axial direction preventing the bushing members from rotating around the distance members.

Preferably the mantle portion fits on the distance member with a loose fit and a filling material is provided filling the gaps between the mantle portion and the distance member. The loose fit reduces or eliminates tensions that might cause fracture of the bushing members. The filling material, such as the adhesive results in an even distribution of the forces acting between the mantle portion and the distance member.

The object of the present invention is further obtained by a wear resistance member for a centrifugal separator. The wear resistance member is shaped as a bushing member having a mantle portion for surrounding a respective distance member at least around a sufficient portion of a circumferential extend of the distance member to prevent removal of the bushing member in a direction perpendicular to an axial direction, and by a set of wear resistance members for a centrifugal separator according to the invention. The set includes bushing members having mantle portions for surrounding a respective distance member at least around a sufficient portion of a circumferential extend of the distance member to prevent removal of the bushing member in a direction perpendicular to an axial direction, and plate members for covering a portion of the radial surface between adjacent bushing members.

The invention will in the following be described in further detail by way of example with reference to the attached schematic drawings.

### BRIEF DESCRIPTION OF THE DRAWINGS

FIG. 1 is a side view of a centrifugal separator,

FIG. 2 is a partial perspective view of a narrow end of a conical part of the bowl and an end member fitted with wear resistance members according to a first embodiment of the present invention,

FIG. 3 is a cross section of a bushing member fitted on a distance member,

FIG. 4 is a perspective view of a second embodiment of a bushing member,

FIG. 5 is a perspective view of a second embodiment of a plate member,

FIG. 6 is a plan view of the plate member of FIG. 5,

FIG. 7 is a cross-sectional view of section along line VII-VII in FIG. 6,

FIG. 8 plate members of the second embodiment assembled into a ring, and is a perspective view of,

FIG. 9 is a perspective view of a third embodiment of the present invention.

### DETAILED DESCRIPTION

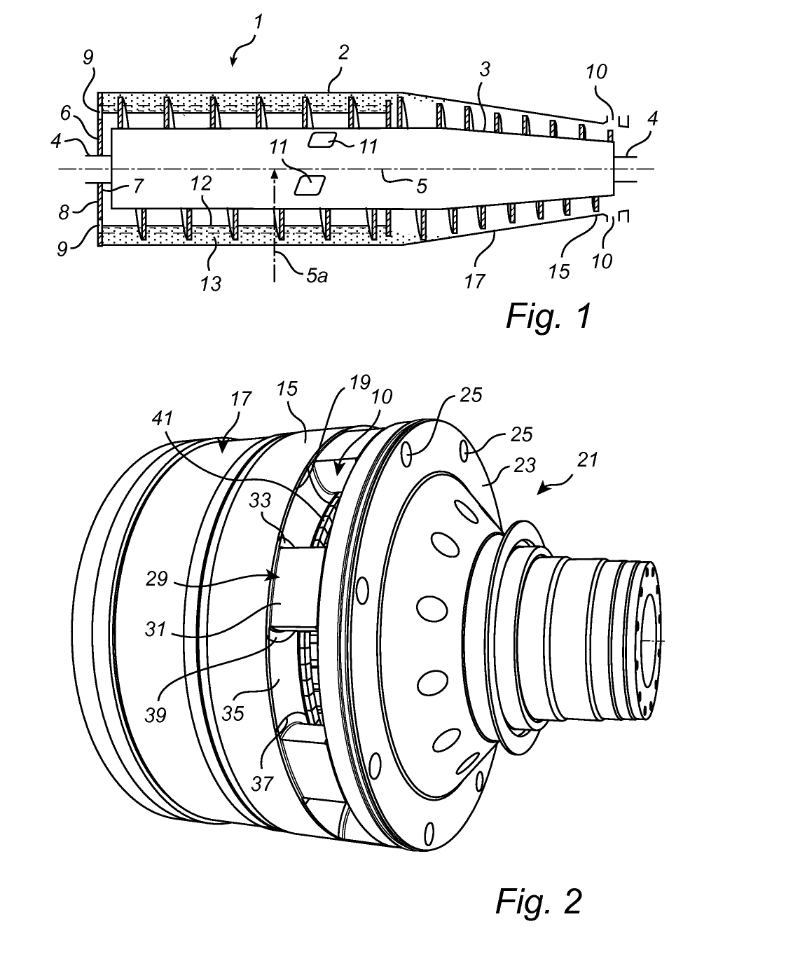

A rotating body 1 of a centrifugal separator or decanter centrifuge schematically shown in FIG. 1 includes a bowl 2 and a screw conveyor 3 which are mounted on a shaft 4 and are rotatable in use around a horizontal axis 5 of rotation. The axis 5 of rotation extends in a longitudinal direction of the bowl 2. Further, the rotating body 1 has a radial direction 5a extending perpendicular to the longitudinal direction.

For the sake of simplicity directions “up” and “down” are used herein as referring to a radial direction towards the axis 5 of rotation and away from the axis 5 of rotation, respectively.

The bowl 2 comprises a base plate 6 provided at one longitudinal end of the bowl 2. The base plate 6 has an internal side 7 and an external side 8. The base plate 6 is provided with a number of liquid phase outlet passages 9 having external openings in the external side 8 of the base plate. Furthermore the bowl 2 has solid phase discharge openings 10 provided at an end opposite to the base plate 6.

The screw conveyor 3 includes inlet openings 11 for feeding a feed e.g. slurry to the rotating body 1. The slurry includes a light or liquid phase 12 and a heavy or solid phase 13. During rotation of the rotating body 1 as previously described, separation of the liquid phase 12 and solid phase 13 phases is obtained. The liquid phase 12 is discharged through the outlet passages 9 in the base plate 6, while the screw conveyor 3 transports the solid phase 13 towards the solid phase discharge openings 10 through which the solid phase 13 is eventually discharged.

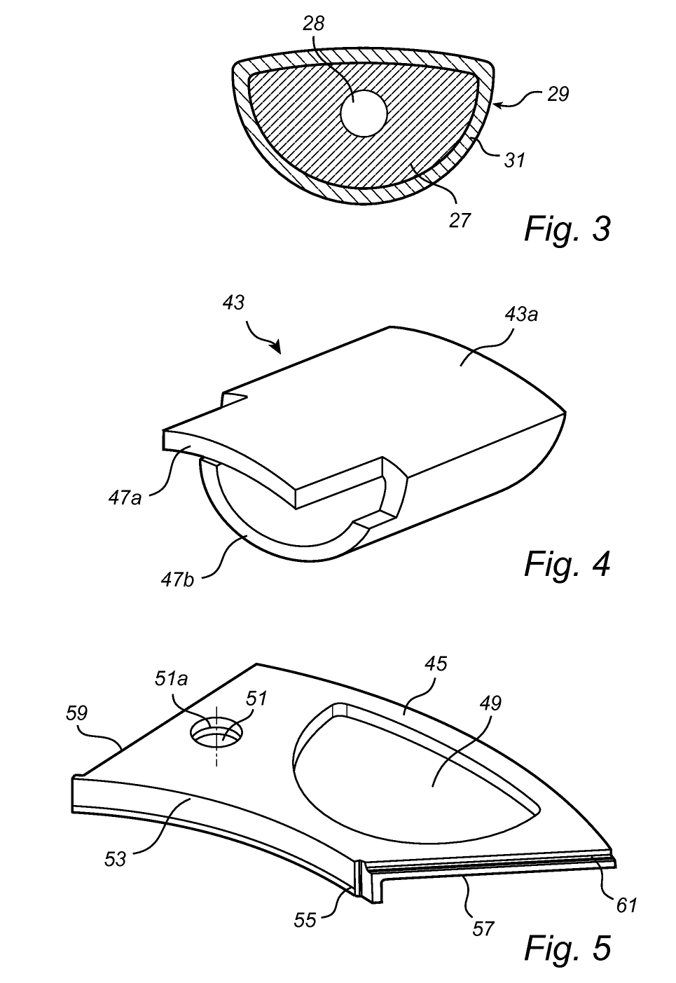

The area around the solid phase discharge openings or outlet openings 10 is shown in more detail in FIG. 2, which shows a narrow end 15 of a conical part 17 of the bowl 2. The narrow end 15 has a radial surface 19 covered by wear resistance members according to a first embodiment of the present invention. An end member 21 of the centrifugal separator has a flange portion 23 with through holes 25 for bolts, not shown, and distance members 27 (see FIG. 3) extending between the radial surface 19 and the flange portion 23. The bolts (not shown) are inserted in the holes 25 and through holes 28 in the distance members 27 to be fastened in the conical part 17 thereby mounting the end member 21 on the conical part 17. The distance members 27 may be integral with the conical part 17 or with the end member 21, or they may be separate elements.

The outlet openings 10 are provided between the distance member 27. The outlet openings 10 shown in FIG. 2 are fitted with wear resistance members, such as those of the first embodiment.

In the first embodiment, bushing members 29 have a tubular mantle portion 31 surrounding the respective distance member 27. Though not circular, the distance members 27 are cylindrical in the shown embodiment and accordingly the tubular mantle portion 31 is also cylindrical to match the distance member. However the distance members and accordingly the tubular mantle portions may be conical, preferably slightly conical.

The tubular mantle portion 31 of the bushing member 29 carries at the end adjacent the radial surface 19 a flange 33 abutting said radial surface.

Between adjacent bushing members 29 plate members 35 are fitted onto the radial surface 19. The plate members have an hourglass-shape with a waist portion 37. Further the adjacent edges 39 of the flanges 33 and the plate members are stepped, whereby the edges of the flanges 33 are overlapping the edges of the plate members 35. Thus the flanges 33 are securing the plate members 35 due to the overlap and the hourglass-shape of the waist portion 37. The bushing members 29 in turn are secured by the fit on the distance members 27 between the radial surface 19 and the flange portion 23. Preferably cement, or a like filler, is used to fill any gaps between the wear resistance members and the adjacent surfaces of the bowl including the end member and especially the distance members. Such filler assist the securing of the wear resistance members and avoid rattling.

The embodiment shown in FIG. 2 further comprises separate corner elements 41 attached by means of glue for the wear protection of the internal edge of the conical part 17 adjacent the radial surface 19.

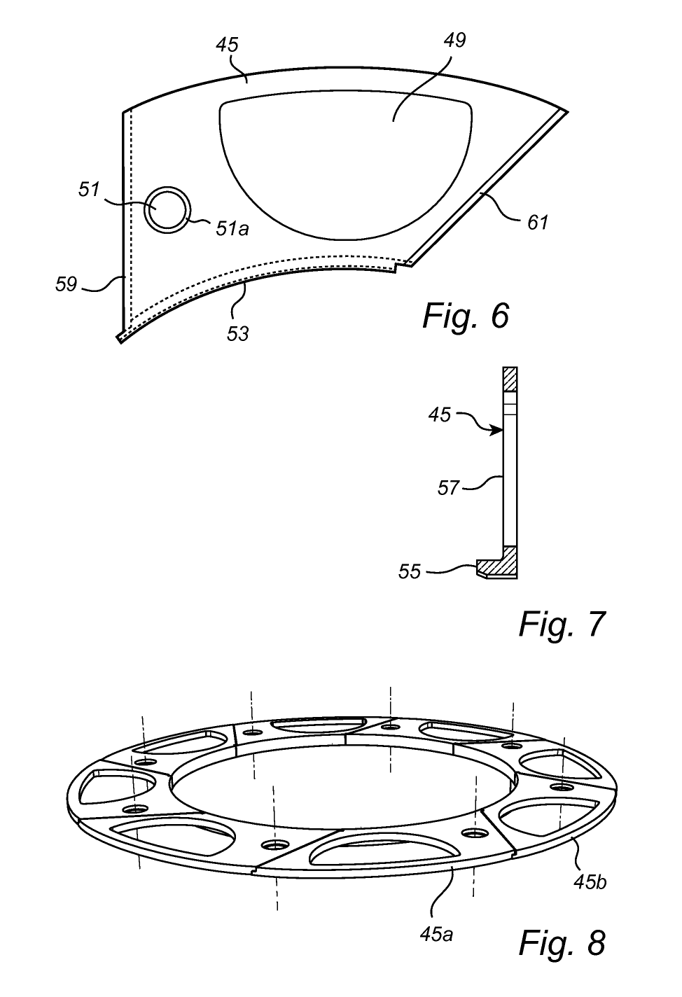

FIGS. 4 to 8 shows a second embodiment of wear resistance members that might be fitted at the outlet openings 10 as an alternative to the bushing members 29 and the plate members 35.

The second embodiment comprises cylindrical bushing members 43 and plate members 45 Like mentioned in relation to the first embodiment, in a variant the bushing members might be more or less conical to correspond to the shape of the distance members 27. The members of the second embodiment being adapted to the same centrifugal separator as the members of the first embodiment, the cross-section of the bushing member 43 of the second embodiment may be identical to the cross-section of the tubular mantle portion of the bushing member 29 of the first embodiment, as shown in FIG. 3. The bushing member 43 has at one end projections 47a, 47b to be received in recesses, not shown, in the flange portion 23.

The plate members 45 are in the second embodiment adapted to form a ring (see FIG. 8) covering the radial surface 19. The plate member 45 has an opening 49 shaped to receive the bushing member 25 with a loose fit. Beside the opening 49 the plate member 45 has a hole 51 with a recessed edge 51a for receiving a fastening member such as a bolt (not shown).

The plate member 45 has a concave edge 53 with an extension 55 rising from the plane of the surface 57 abutting the radial surface 19 when the plate member has been mounted, whereby the extension 55 extends around the internal edge of the conical part 17 adjacent the radial surface 19 to protect said internal edge. Accordingly, the extension 55 is similar to the separate corner elements 41 of the first embodiment.

At either end of the concave edge 53 the plate member has stepped edge 59, 61, whereby the stepped edges are oppositely stepped so that an edge 59 adjacent the hole 51 of one plate member 45a may overlap an edge 61 adjacent the opening 49 of a neighbouring plate member 45b when the plate members 45 are mounted to form a ring on the radial surface 19.

Mounting of the plate members 45 is performed as follows: The plate members 45 are assembled into a ring as shown in FIG. 8 on a flat steel ring (not shown). The steel ring comprises openings corresponding to the openings 49 for the distance members 27 to extend through and holes corresponding to the holes 51, but having a smaller diameter. The plate members 45 are fastened to the steel ring by means of e.g. glue and the steel ring is fastened to the radial surface 19 of the narrow end of the bowl of the centrifugal separator by means of bolts with a head so shaped that the bolt is tightened against the rim of the hole in the steel ring without abutting, but only overlaying, the recessed edge 51a of the hole 51 in the plate member. The head of the bolts are accommodated in the holes to be protected from wear. Overlaying the recessed edge 51a the head of the bolt secures the plate member to prevent its removal in case the glue should fail. The stepped edge 59 of one plate member secured by a bolt through the hole 51 will secure the opposite stepped edge 61 of the neighbouring plate member 45b in case the glue should fail.

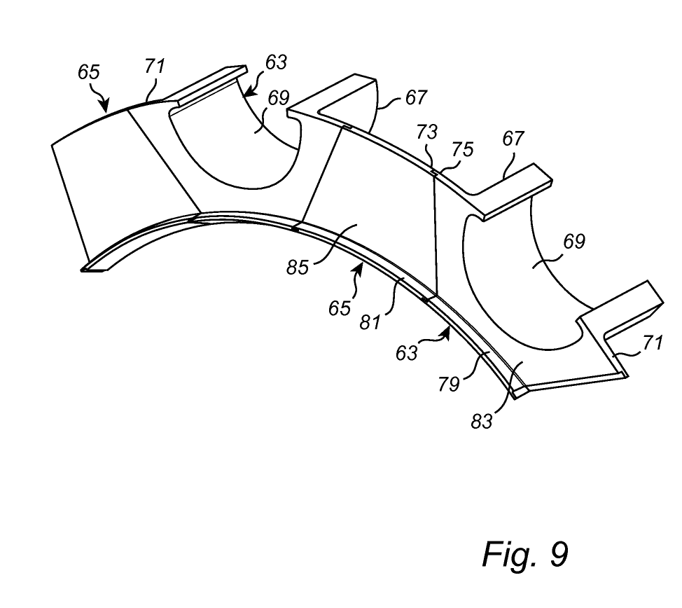

FIG. 9 shows a perspective view of four members of a third embodiment, namely two bushing members 63 and two plate members 65. This embodiment combines various features of the first and second embodiments together with some new features. Thus the bushing members 63 comprise a mantle portion 67 with a C-shaped cross-section. When the bushing member has been mounted the mantle portion 67 will surround the distance member sufficiently to prevent the bushing member from being removed in a direction perpendicular to the axial direction.

Moreover, the non-circular cross-section of an inner wall 69 of the bushing member, which corresponds to the cross-section of the distance member, prevents the bushing member 63 from rotating around the distance member. This applies also the first and second embodiments described above.

The bushing member 63, like the bushing member of the first embodiment, has a flange 71 for abutting the radial surface of the narrow end of the bowl of the centrifugal separator. The plate members 65 and the bushing members have in this third embodiment straight overlapping adjacent edges. Thus the plate member 65 has stepped edges 73 and the bushing member has overlapping stepped edges 75. Thus, when mounted, the bushing members secure the plate members in the axial direction and in the downward radial direction. The bushing member 63 and the plate member 65 further have, at their concave edges, respective extensions 79, 81 rising from the plane of the adjacent surfaces 83, 85, respectively. These extensions 79, 81 correspond to the extensions 55 of the plate members 45 of the second embodiment.

The straight overlapping edges 73 and 75 extend along the ends of the extensions 79, 81, and thus the bushing members 63 also secure the plate members 65 in the upwardly radial direction.

It should be noted that further mixing of features of the three embodiments are possible. For example in the third embodiment it would be possible to use tubular mantle portions surrounding the distance members completely, like in the first embodiment.

Although this invention has been shown and described with respect to the detailed embodiments thereof, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1-15. (canceled)

16. A centrifugal separator comprising:
a bowl rotating in use in a direction of rotation around an axis of rotation extending in a longitudinal direction of the bowl, said bowl comprising a conical part with a narrow discharge end comprising a radial surface;
an end member opposite the radial surface;
a plurality of distance members extending between the radial surface and the end member and providing outlet openings between adjacent distance members, said distance members having an axial extend in an axial direction of the axis of rotation and a circumferential extend perpendicular to the axial extend;
and wear resistance members covering surfaces at the outlet openings,
wherein the wear resistance members comprise a bushing member with a mantle portion surrounding a respective distance member at least around a sufficient portion of the circumferential extend of said distance member to prevent removal of the bushing member in a direction perpendicular to the axial direction.

17. A centrifugal separator according to claim 16, wherein the mantle portion of the bushing member is tubular and circumferentially surrounds the distance member completely.

18. A centrifugal separator according to claim 16, wherein the mantle portion of the bushing member has a C-shaped cross-section perpendicular to the axial direction.

19. A centrifugal separator according to claim 16, wherein the wear resistance members comprise a plurality of plate members each covering a portion of the radial surface.

20. A centrifugal separator according to claim 16, wherein the bushing member at one end has a flange abutting the radial surface and covering a portion of said radial surface.

21. A centrifugal separator according to claim 20, wherein a plate member is fitted on the radial surface between adjacent bushing members, edges of the flanges of the bushing members overlapping edges of the plate members.

22. A centrifugal separator according to claim 21, wherein the plate members have a waist portion, the flanges being configured to engage the waist portion and secure the plate members due to the overlap and the waist portion.

23. A centrifugal separator according to claims 16, wherein the plate members respectively comprise an opening for a distance member to extend through, and that an edge of a plate member overlaps an adjacent edge of an adjacent plate member.

24. A centrifugal separator according to claim 23, wherein the plate member comprises a hole for a fastening member, and the opening for a distance member is adapted to accommodate an end of a bushing member.

25. A centrifugal separator according to claim 19, wherein a concave edge of the wear resistance members covering a portion of the radial surface comprise an extension rising from a plane of the wear resistance member, whereby the extension is arranged to extend around an internal edge of the conical part adjacent the radial surface to protect said internal edge.

26. A centrifugal separator according to claim 16, wherein the wear resistance members comprise tungsten carbide.

27. A centrifugal separator according to claim 16, wherein the distance members, and accordingly the mantle portions of the bushing members, have a non-circular cross-section perpendicular to the axial direction preventing the bushing members from rotating around the distance members.

28. A centrifugal separator according to claim 16, wherein the mantle portion fits on the distance member with a loose fit and a filling material is provided filling the gaps between the mantle portion and the distance member.

29. A wear resistance member for a centrifugal separator; wherein the wear resistance member is shaped as a bushing member having a mantle portion for surrounding a respective distance member at least around a sufficient portion of a circumferential extend of said distance member to prevent removal of the bushing member in a direction perpendicular to an axial direction.

30. A set of wear resistance members for a centrifugal separator; comprising bushing members having mantle portions for surrounding a respective distance member at least around a sufficient portion of a circumferential extend of said distance member to prevent removal of the bushing member in a direction perpendicular to an axial direction, and plate members for covering a portion of the radial surface between adjacent bushing members.
